(19) United States
(12) Patent Application Publication
(10) Pub. No.: US 2003/0116579 A1
(43) Pub. Date: Jun. 26, 2003

(54) Plastic chime ring and apparatus

(76) Inventor: James D. Chambers, Lawrenceville, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/028,515

(22) Filed: Dec. 20, 2001

(51) Int. Cl. A23B 4/00

(52) U.S. Cl. 220/912

(57) ABSTRACT

A plastic chime ring capable of being attached to a knock-down drum without the use of adhesives, seaming or welding is disclosed. The chime ring comprises an annular upper portion, an outer ring portion and inner ring portion wherein the inner and outer ring portions define a U-shaped opening throughout the circumference of the ring and at least one ring portion has a locking mechanism on its inner edge. The outer ring portion includes a flange that allows the chime ring and drum to be removed from an attachment apparatus without the chime ring and drum being separated from each other. The inner ring portion includes a curved edge on its outer surface that guides the rim of a knock-down drum into the U-shaped opening. Apparatus for attaching the chime ring to a knock-down drum is disclosed. The apparatus includes an adjustable shaft, a narrowed mandrel and a collapsible guide.

### BACKGROUND OF THE INVENTION

1. Field of the Invention

The present invention relates to a plastic chime ring for attachment to a knock-down drum. The invention also relates to an apparatus for the attachment of a plastic chime ring to a knock-down drum.

2. Description of the Related Art

Fiberboard drums, or knock-down drums as they are often referred to, are commonly used to store and ship a variety of materials. The primary advantage of knock-down drums is that they can be manufactured in tubular form and then shipped or stored in flat form, which presents substantial savings in terms of space usage. Another advantage is that knock-down drums are comprised of paper and can be printed inexpensively, unlike plastic containers.

Knock-down drums may be used for packing a variety of materials. For example, knock-down drums may be used to store or ship dry flowables, such as road salt. They may also be used for storage or shipping of food products. The fiberboard may either be laminated or nonlaminated, depending on the material packed in it. The surfaces of the fiberboard drum can be lined with a protective coating impervious to liquids to further protect the contents.

Knock-down drums typically included rolled edges on smaller containers and metal rims on larger containers. Rolled edges, while inexpensive to manufacture, do not provide sufficient support for larger containers. Rolled edges may not provide sufficient stiffniess to retain a circular shape. Over time, rolled edges may also unroll, causing lids to be improperly secured. Metal chimes provide the support needed for larger containers, but can lead to several problems. Even when galvanized, metal chimes are subject to rusting, which can reduce the integrity of the seal between the chime and the cover. Metal chimes may also experience corrosion and weakening due to reaction between the metal and the product within the drum. Corrosion, like rusting, can degrade the seal between the chime and the cover, which may ultimately cause contamination of the product. Metal chimes may have sharp edges or burrs that can pose a safety hazard to those handling the knock-down drums. For example, personnel handling drums with metal chimes are more likely to suffer lacerations from sharp edges or burrs. Knock-down drums with metal chimes are also difficult to dispose of. The fiberboard material can be easily incinerated or recycled, but disposing of the metal chimes requires an additional procedure. Finally, metal chimes are susceptible to impact damage. Forces imparted upon a metal chime can result in denting and bending. This may cause lids to be improperly secured and prevent the knock-down drum from retaining the desired circular shape.

There have been a variety of previous attempts in the use and manufacture of a top closure member for use with knock-down drums. Earlier attempts to produce such drums consistently suffer from disadvantages. Knock-down drums are shipped in a flattened configuration and have a tendency to retain a somewhat elliptical shape until they are finally formed. This has presented a problem in the proper nesting of chime rings on the drum.

Plastic presents an advantage over metal in that it is not susceptible to rust, corrosion or burring. Previous attempts to use a plastic chime ring in place of rolled edges or a metal chime have required that the chime ring be welded or attached with adhesive to a knock-down drum. For example, the use of a plastic chime ring attached to a drum via adhesives, stapling, riveting, stitching, sewing, bonding or interference fitting has been described. Chime rings not formed as a continuous ring are known, but such rings must be welded together, thus adding to manufacturing costs. A plastic chime ring with locking tabs is also known. The tabs fit into notches cut out of the tube and the ring is vibrationally welded onto the drum. Similarly, a plastic reinforcing ring with thin-walled projections or weld lamellas is known. The projections or lamellas are heated so that the ring may be welded to a paper container. Accordingly, there is a need in the art to provide a chime ring that does not require specially prepared tubes or welding.

A plastic end closure member with a groove and tapered inner and outer chime portions has been described, but it also must be welded to a container body. A plastic ring with an elongated groove that is funnel shaped at the open end to provide a means for guiding a drum into the groove is known in the art. The ring is pressed onto the drum, but a cover member fits into the interior central area of the ring, below the top surface of the drum to lock the ring in place. Such a ring is not capable of being attached to a drum without the cover member. There is a therefore a need in the art to provide a plastic chime ring that may be secured to a tube without adhesives or welding and does not require a specially adapted cover member.

It has been found that the effective commercial use of a knock-down drum requires both a bottom closure member and a top closure member. It is known to use a metal disk as a bottom for knock-down drums. For example, U.S. Pat. No. 3,057,265 to Leibreich, which is incorporated herein by reference, describes how such drums can be formed and a metal bottom seamed onto the bottom-most edge of the drum. In this fashion, a knock-down drum is formed having a sealed bottom, but no top. Moreover, machines for attaching a chime ring to a knock-down drum, such as that of the '265 patent, typically were incapable of simultaneously attaching a chime ring to the top of the knock-down drum and attaching a bottom to the bottom of the knock-down drum. Such machines also often included a shaft which was not adjustable, and as such, could only be used for knock-down drums of a particular height.

Other drum closure assembly positioning apparatus are adjustable so that drums of different sizes may be used, but forced air must be used to retain the knock-down drum in a circular shape and to keep it in proper alignment. Additionally, these prior art machines cannot simultaneously attach a bottom and a chime ring to a drum.

Machines that attach reinforcing rings to the top and bottom of a knock-down drum are known, but most are for use with metal chime rings and attachment occurs by clamping or clinching the rings to the ends of a knock-down drum. These machines are not capable of attaching a chime ring by merely pressing the ring onto the end of a drum.

### SUMMARY

The present invention solves these and other problems which have been appreciated by the prior art. One feature of this invention is the use of a plastic chime ring which imparts the support of a metal chime ring without the problems associated with metal chimes, such as sharp edges, burring, corrosion or rusting. Another feature of the plastic chime ring is a locking mechanism that grips the rim of a tube, eliminating the need for adhesives or welding. Another feature of this invention is the curved paper guide that guides the rim of a tube into the U-shaped opening of the chime ring. The paper guide reduces the risk of the tube catching on the edges of the chime ring or failing to form the desired circular shape. An additional feature of this invention is a flange that allows the chime ring and the tube to be removed from the attachment apparatus without separating the chime ring from tube. The tube may be a fiberboard drum, a knock-down drum or any other container commonly used to ship or store materials.

One feature of the attachment apparatus of this invention is an adjustable shaft that allows the apparatus to be used to attach chime rings to tubes of various sizes. Another feature of this invention is the collapsible mandrel at the upper end of the adjustable shaft. The collapsible mandrel allows the chime ring and tube to be removed together without the chime ring catching on the mandrel and separating from the tube.

The present invention is directed to a container that satisfies the needs described above. A plastic chime ring having features of the present invention imparts the support of a metal chime ring without drawbacks present with metal chimes, such as rusting, corrosion, sharp edge or burring. The present invention is an improvement over known plastic chime rings because it does not need not be welded or secured with adhesive to a tube. The present invention also solves the problem of improper nesting of the ring on the tube through the use of a curved paper guide on the outer edge of the inner leg. The paper guide prevents the tube from catching on the edge of the chime ring.

A container having features of the present invention comprises a tubular drum shell having a side wall extending upwardly and defining an upper opening and, attached about the upper opening, a plastic chime ring comprising an annular upper portion, an outer ring portion and an inner ring portion, wherein the inner and outer ring portions define a U-shaped opening continuous throughout the circumference of the plastic chime ring, and one ring portion has a locking mechanism on its inner edge.

In a particular embodiment of the invention, the locking mechanism of the plastic chime ring is on the outer ring portion.

In another embodiment of the invention, the inner ring portion of the plastic chime ring has a curved edge on its outer surface.

In a more particular embodiment, the curved edge guides the rim of a tube into the U-shaped opening of the plastic chime ring.

In another embodiment of the invention, the inner ring portion of the plastic chime ring has a flange on its inner surface that curves outward.

In a more particular embodiment, the flange curves outward such that during manufacture it contacts a mandrel of a machine used to attach the plastic chime ring to a tube. The flange is curved such that when the plastic chime ring and tube are attached to each other and then removed from the machine together, the plastic chime ring is not separated from the tube.

In another embodiment of the invention, the outer ring portion of the plastic chime ring extends adjacent to an outer edge of a tube.

In another embodiment of the invention, the inner ring portion of the plastic chime ring extends adjacent to an inner edge of a tube.

In another embodiment of the invention, the locking mechanism of the plastic chime ring grips an upper edge of a tube.

In another embodiment of the invention, the tube is filled with food or dry flowables.

The invention also relates to an apparatus for attaching a plastic chime ring to a tube that satisfies the needs described above. An apparatus having features of the present invention comprises a frame and a support means carried by the frame and adapted to respectively carry the chime ring and the tube and maintain the chime ring on the open end of the tube. The support means may be pivotally connected to the frame and adjustable. The support means may include a first mandrel disc adapted to be telescopically received in the tube and a second mandrel disc adapted to be received in both the central portion of the plastic chime ring and the tube. The mandrels are of a width to receive a chime ring. The second mandrel is located at the base of the support means and the upper portion of the support means is collapsible.

The invention is also directed to a method for attaching a plastic chime ring to a tube that satisfies the needs described above. A method having features of the present invention comprises inserting a plastic chime ring over the support means of the apparatus described such that the plastic chime ring rests on the second mandrel. Then, a tube is inserted over the support means of the apparatus described above. Next, a preformed bottom is secured to the tube and the tube is simultaneously pressed into the chime ring. Finally, the first mandrel is collapsed such that the tube and the plastic chime ring can be removed from the apparatus.

In a particular embodiment of the present invention, the method above further comprises filling the tube with food or dry flowables.

### BRIEF DESCRIPTION OF THE DRAWINGS

FIG. 1 is a vertical cross-sectional view of a plastic chime ring according to one embodiment of the present invention attached to a knock-down drum.

FIG. 2 is a perspective view of the underside of a plastic chime ring according to one embodiment of the present invention.

FIG. 3 is an exploded view of a disassembled plastic chime ring, knock-down drum and preformed bottom.

FIG. 4 is a perspective view of a plastic chime ring according to one embodiment of the present invention attached to a knock-down drum which is filled with food.

FIG. 5 is a perspective view of an apparatus according to one embodiment of the present invention.

FIG. 6 is a perspective view of an apparatus according to one embodiment of the present invention with a chime ring and knock-down drum located thereon.

### DETAILED DESCRIPTION OF SPECIFIC EMBODIMENTS OF THE INVENTION

This invention will now be described more fully with reference to the drawings, showing preferred embodiments of the invention. However, this invention can be embodied in many different forms and should not be construed as limited to the embodiments set forth.

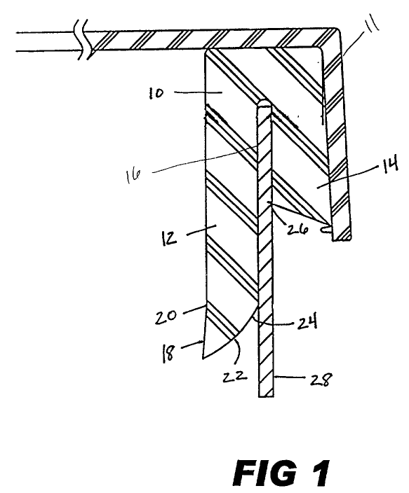

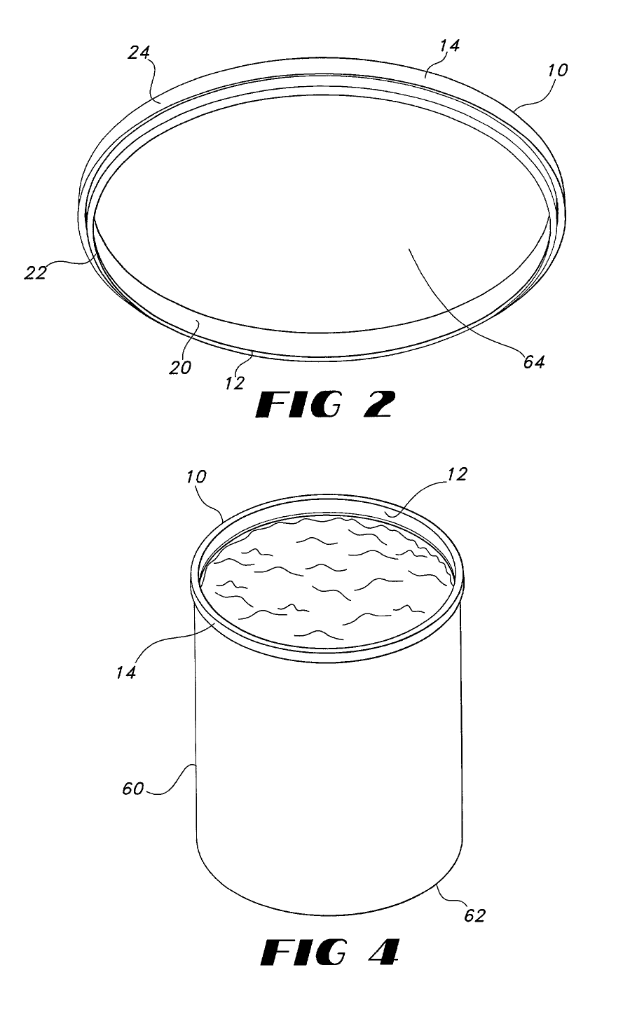

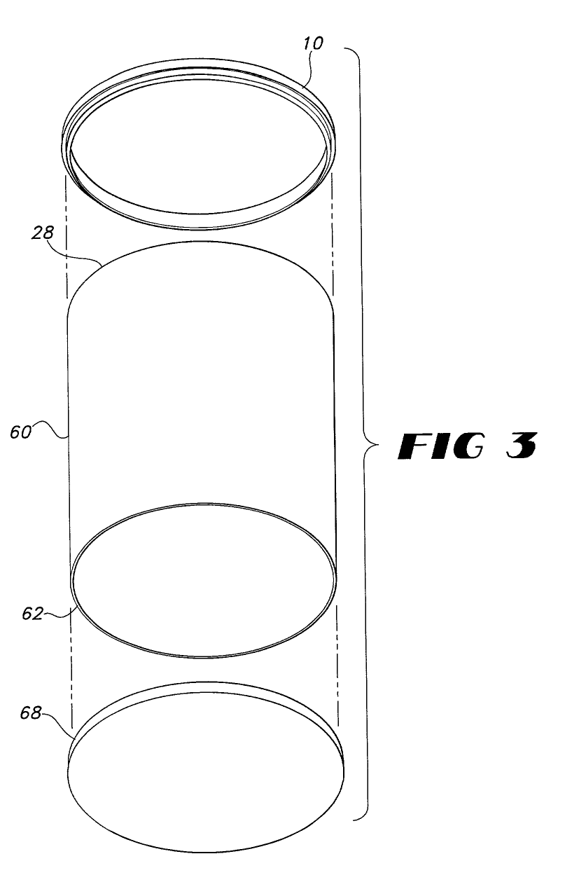

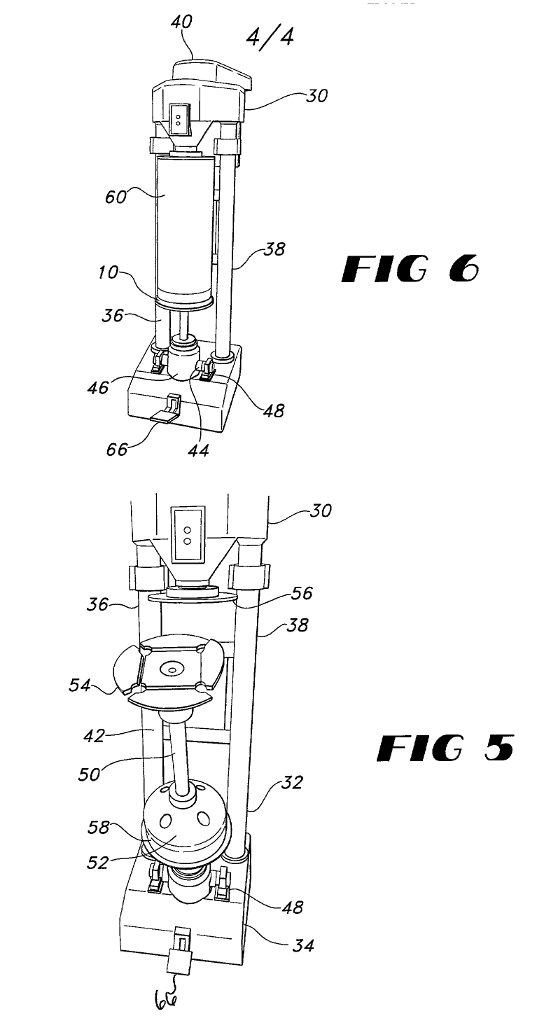

As shown in FIG. 2, plastic chime ring 10 of one embodiment of the invention is substantially circular and has inner ring portion 12 and outer ring portion 14 which form a U-shaped opening 16 (as shown in FIG. 1). Alternatively, the ring may be elliptical or any other shape desired that conforms to the shape of the container to which the ring is to be attached. As shown in FIG. 1, in use outer ring portion 14 extends adjacent to the outer portion of a upper open end 28 of tube 60 (as shown in FIG. 3) and inner ring portion 12 extends adjacent to the inner portion of the upper open end 28. Inner ring portion 12 and outer ring portion 14 may be of different lengths as shown in FIGS. 1 and 2 or they may be of substantially the same length. The ring 10 has a small flange 18 on the inner edge 20 of inner ring portion 12 that curves outward such that during manufacture, the flange 18 contacts a mandrel of a machine used to attach the ring to a drum. Thus, as shown in FIGS. 5 and 6, when the plastic chime ring 10 is inserted over a shaft 50 of an attachment apparatus 30, the small inner flange 18 of the ring 10 contacts the mandrel 52 of the apparatus 30, so that the ring 10 is held securely in place while the tube 60 is attached. However, when the chime ring 10 has been attached to the tube 60 and both are removed from the attachment apparatus 30, the flange 18 is curved such that the ring 10 and tube 60 slips off the mandrel 52 together without ring 10 being separated from tube 60.

As shown in FIGS. 1 and 2, the plastic chime ring 10 also features a paper guide 22 on the outer surface 24 of inner ring portion 12. The paper guide 22 is slightly curved and guides the upper open end 28 of the tube 60 into the U-shaped opening 16 (shown in FIG. 1). An additional feature of the plastic chime ring 10 is that it may have a locking mechanism 26 on the inner surface of outer ring portion 14 that can grip and lock the upper open end 28 once it has been pressed down onto the plastic chime ring 10. Alternatively, the locking mechanism 26 may be located on the outer surface 24 of inner ring portion 12. The locking mechanism 26 may lock the upper open end 28 by friction. In one embodiment of the invention, the locking mechanism 26 is comprised of a plurality of dimples that allow a tube to slide into the U-shaped opening 16, then exert sufficient pressure on the tube to prevent it from being readily removed from the ring 10.

A top closure member (not shown) may be used to seal the top of the container. The plastic chime ring 10 is designed to be used with a with a common snap-on lid. This feature of the invention eliminates the need for specially designed top closure members.

In a particular embodiment of this invention, the upper portion of the plastic chime ring 10 is about 0.25 inches to about 0.33 inches, more particularly about 0.2850 inches wide. The distance from the flange 18 to the outer surface of outer ring portion 14 is about 0.30 inches to about 0.43 inches, more particularly about 0.3179 inches. The total length of inner ring portion 12 is about 0.65 inches to about 0.85 inches, more particularly about 0.750 inches. The total length of the outer ring portion 14 is about 0.40 inches to about 0.51 inches, more particularly about 0.4375 inches, with the locking mechanism 26 measuring approximately 0.009 inches to about 0.015 inches, more particularly about 0.010 inches. The U-shaped opening 16 is about 0.020 inches to about 0.040 inches wide, more particularly about 0.035 inches wide, and about 0.20 inches to about 0.30 inches deep, more particularly about 0.250 inches deep.

As shown in FIG. 4, the container of the present invention may be used to hold and ship food or dry flowables, such as asphalt, road salt, etc. When used to store and ship food, it may be necessary to coat or otherwise line the tube to comply with food storage guidelines.

FIG. 5 illustrates an embodiment of an attachment apparatus 30 formed in accordance with the teachings of this invention. The apparatus 30 includes a frame 32, comprising a base member 34, a pair of parallel cylindrical supports 36 and 38 extending vertically from the base member 34, and a top member 40 carried at the upper ends of the supports 36 and 38.

A lower support member 42 may be pivotally connected to the base member 34 by a pair of opposed trunnions 44 extending outwardly from a frame 46 supporting lower support member 42 and being respectively received within suitable bearing supports 48 secured to the base member 34. The frame 46 of the support 42 can rotatably support an adjustable shaft 50 carrying a mandrel 52 at the lower end thereof as shown in FIG. 5 and a flat collapsible mandrel 54 at the upper end thereof. The lower support member 42 may be adapted to cooperate with an upper disc-like mandrel 56.

The upper disc-like mandrel 56 can be rigidly secured to a rotatably driven shaft extending vertically downwardly from the top member 40. The attachment apparatus 30 illustrated in FIG. 5 is adapted to secure a chime ring 10 (see FIG. 6) to an upper open end 28 of a tubular tube 60 which may, for example, comprise a cellulose fiber, glass fiber, certain metal or plastic materials. In a particular embodiment, the tube 60 comprises a fiberboard drum. In a more particular embodiment, the tube 60 comprises a knock-down drum.

As shown in FIG. 6, plastic chime ring 10, comprising a circular central portion 64, an inner ring portion 12 and an outer ring portion 14, may be adapted to be telescoped onto lower support member 42 and to come to rest on mandrel 52.

The plastic chime ring 10 may be telescoped onto the lower support member 42 when the support member 42 is in the position illustrated in FIG. 5. After the plastic chime ring 10 has been telescoped onto the lower support member 42, the cylindrical tube 60 can be telescoped onto the lower support member 42. The lower open end 62 of the tube 60 rests against the peripheral portion of the flat collapsible mandrel 54 and the upper open end 28 of the container body 60 rests against the peripheral portion 58 of the mandrel 52. The mandrel 52 may be constructed so that it closely receives the internal peripheral surface of the tube 60 and maintains the tube 60 in its cylindrical shape. The upper open end 28 of the tube 60 can be assembled on the chime ring 10 whereby the central portion 64 and the inner ring portion 12 of the chime ring 10 are closely received within the upper open end 28 of the container body 60. The outer peripheral portion 66 of the chime ring 10 can engage the upper open end 28 of the tube 60 and the outer ring portion 14 may be disposed slightly spaced from the peripheral portion 58 of mandrel 52.

When the tube 60 has been completely telescoped onto the lower support member 42, an annular section (not shown) of the tube 60 thereof extends above the disc-like mandrel 54, which is preferably spring-loaded. A bottom closure member 68 (as shown in FIG. 3) may be seamed to lower open end 68 according to method described in U.S. Pat. No. 3,057,265 to Leibreich. The flat collapsible mandrel 54 may also closely engage the internal peripheral surface of the tube 60 and maintains the upper portion of the body in its cylindrical shape. In this manner, the support member 42 can force the tube 60 into the desired cylindrical shape.

When the upper open end 28 of the tube 60 is assembled to chime ring 10 in the manner described above and a bottom closure member is assembled to the lower open end 62 of the tube 60, the lower support member 42 is pivoted to its vertical position and raised vertically upwardly by the lever 74 whereby the mandrel 52 may be telescopically received within the annular wall 70 of the chime ring 10 and forces the circular portion 64 of the chime ring 10 into frictional engagement with the mandrel 58 (see FIG. 6).

The length of the rod 50 may be adjustable so that when the assembled chime ring 10 and tube 60 are raised upwardly against the disc-like mandrel 56, the disc-like mandrel 56 forces the chime ring 10, tube 60 and mandrel 52 downwardly relative to the shaft 50 until the central portion 64 of the chime ring 10 makes contact with the peripheral portion 58 of mandrel 52. A spring (not shown) located at the bottom of adjustable shaft 50 may be slightly compressed and tends to force the tube 60 and chime ring 10 into frictional engagement with each other and the chime ring 10 into frictional engagement with the mandrel 52. Simultaneously, a bottom closure member 68 may be seamed to the open end 62 of the tube 60 according to the method described in U.S. Pat. No. 3,057,265 to Leibreich.

When both the bottom closure member and the chime ring 10 have been attached to the tube 60, the flat collapsible mandrel 54 may be collapsed so that the chime ring 10 and tube 60 can be removed without the outer surface 24 of the inner ring portion 12 catching on the mandrel 54. The flange 18 prevents the outer surface 24 of the inner ring portion 12 from sticking on the mandrel 52. In this way, the flange 18 assures that the chime ring 10 will not separate from the tube 60 when the chime ring 10 and the tube 60 are removed together from the apparatus 30.

The particular embodiments of the invention illustrated and described above are not limiting of the present invention, and those of skill in the art can readily determine that additional embodiments and features of the invention are within the scope of the appended claims and equivalents thereto.

What is claimed is:

1. A container comprising:
a) a substantially cylindrical tube having a side wall extending upwardly and defining an upper opening; and
b) attached about the upper opening, a plastic chime ring comprising:
i) an annular upper portion;
ii) an outer ring portion; and
iii) an inner ring portion
wherein the inner and outer ring portions define a U-shaped opening throughout the circumference of the plastic chime ring, and at least one ring portion has a locking mechanism on its inner edge.

2. The container of claim 1 wherein the locking mechanism is on the outer ring portion of the plastic chime ring.

3. The container of claim 1 wherein the locking mechanism is a friction lock.

4. The container of claim 1 wherein the locking mechanism is comprised of a plurality of dimples.

5. The container of claim 1 wherein the inner ring portion of the plastic chime ring has a curved edge on its outer surface.

6. The container of claim 5 wherein the curved edge guides the rim of the tube into the U-shaped opening of the plastic chime ring.

7. The container of claim 1 wherein the inner ring portion of the plastic chime ring further comprises a flange on its inner surface that curves outward.

8. The container of claim 7 wherein the flange curves outward such that during manufacture it contacts a mandrel of a machine used to attach the plastic chime ring to the tube.

9. The container of claim 1 wherein the outer ring portion of the plastic chime ring extends adjacent to an outer edge of the tube.

10. The container of claim 1 wherein the inner ring portion of the plastic chime ring extends adjacent to an inner edge of the tube.

11. The container of claim 1 wherein the locking mechanism grips an upper edge of the tube.

12. The container of claim 1 wherein a bottom is attached about the lower opening of the tube.

13. The container of claim 12 wherein the tube is filled with food.

14. The container of claim 12 wherein the tube is filled with dry flowables.

15. Apparatus for securing a plastic chime ring to a tube comprising:
a) a frame;
b) a support means carried by the frame and adapted to respectively carry the chime ring and the tube and maintain the plastic chime ring on the open end of the tube;
c) wherein the support means pivotally connects to the frame;
d) wherein the support means is adjustable;
e) wherein the support means includes a first mandrel disc adapted to be telescopically received in the tube and a second mandrel disc adapted to be received in both the central portion of the plastic chime ring and the tube;
f) wherein the mandrels are of a width to receive a plastic chime ring;
g) wherein the second mandrel is located at the base of the support means; and
h) wherein the upper portion of the support means is collapsible.

16. A method for attaching a plastic chime ring to a tube comprising:
a) inserting a plastic chime ring over the support means of the apparatus of claim 15 such that the plastic chime ring rests on the second mandrel;
b) inserting a tube over the support means of the apparatus;
c) securing a preformed bottom to the tube and simultaneously pressing the tube into the plastic chime ring; and
d) collapsing the first mandrel of the apparatus such that the tube and the plastic chime ring can be removed from the apparatus.

17. The method of claim 16 further comprising filling the tube with food or dry flowables.
